(19) United States
(12) Patent Application Publication
(10) Pub. No.: US 2009/0161378 A1
(43) Pub. Date: Jun. 25, 2009

(54) Slim profile light assembly for an exterior vehicle mirror

(76) Inventor: Andreas Enz, Columbia, SC (US)

Correspondence Address: MCNAIR LAW FIRM, P.A., P.O. BOX 447, GREENVILLE, SC, 29602-0447, US

(21) Appl. No.: 12/012,247

(22) Filed: Feb. 1, 2008

Related U.S. Application Data
(60) Provisional application No. 61/008,630, filed on Dec. 20, 2007.

(51) Int. Cl. B60Q 1/26; F21V 9/00

(52) U.S. Cl. 362/494; 362/511

(57) ABSTRACT

A slim profile lighting assembly for an exterior rearview mirror comprising a light transmissive panel disposed on an exterior side of a mirror housing; a flat woven fiber optic web carried by said housing adjacent said light transmissive panel; and, a light source connected to said fiber optic web for channeling light through said fiber optic web so that light emitted from said fiber optic web passes through said light transmissive panel.

### CROSS REFERENCE TO RELATED APPLICATION

This application claims priority from U.S. Provisional Application Ser. No. 61/008,630 filed Dec. 20, 2007 having the same title.

### BACKGROUND OF THE INVENTION

1) Field of the Invention

The invention relates to exterior rearview vehicle mirrors, and more particularly, to a slim profile light assembly for illuminating a light transmissive panel in a mirror housing that provides a compact and flush to the housing design so that a slimmer construction and overall appearance can be applied to the mirror housing.

2) Description of Related Art

Exterior vehicle mirror assemblies have increasingly been incorporated with various lighting systems for illuminating indicators, displaying indicia, and the like. A problem has arisen in that typical lighting systems require significant amounts of interior volume within the mirror assembly housing. For example, incandescent light bulbs require various socket and mounts, and the bulbs themselves are comparatively large given the limited space for mounting other operational components for the mirrors. Smaller light sources such as LEDs are an improvement over incandescent bulbs and are used regularly in current mirror assemblies. However, these LED arrangements, such as a turn signal indicator, require large mounting plates and related components to support the LEDs in a patterned arrangement, thus negating the benefit of the smaller light source.

Additionally, traditional light sources such as incandescent light bulbs and LEDs do not provide a uniform light transmission over a given surface area, but rather have intense points of light emitted at staggered locations throughout a given area. Various light diffusion and control mechanisms are known in the prior art to dissipate the light to attempt to provide uniform appears, such as for turn signals and the like. The control mechanisms can add unnecessary complexity and cost to the mirror assemblies when a uniform light distribution is preferred.

The prior art is replete with such mirror assemblies and clearly illustrate the large interior volumes of the mirror housing consumed by such displays. When adding other components such as a mirror heating system, radio antenna equipment, motor assemblies, carrier plates, power systems, and other common design elements, the mirror housings become large. The larger the mirror assembly, the heaver it becomes and the more prone to failure due to excessive wear and tear on the support elements. Further, because of the support systems components used to power and control traditional lighting systems as described above, they cannot be easily carried on the housing in a flush arrangement with the housing to provide for an overall slim appearance.

Thus, a need has arisen for a slim profile lighting system that can illuminate indicators and the like in a mirror housing with a uniform light distribution, while using less interior volume and which can be flush mounted to the mirror housing to allow for a slimmer mirror housing design.

Accordingly, it is an object of the present invention to provide a slim profile lighting system that utilizes less interior space in a vehicle mirror housing and provides a uniform light distribution.

### SUMMARY OF THE INVENTION

The above objectives are accomplished according to the present invention providing a slim profile lighting assembly for an exterior rearview mirror comprising a light transmissive panel disposed on an exterior side of a mirror housing; a flat woven fiber optic web carried by the housing adjacent the light transmissive panel; and, a light source connected to the fiber optic web for channeling light through the fiber optic web so that light emitted from the fiber optic web passes through the light transmissive panel.

In a further embodiment, the light transmissive panel comprises a translucent reflector for controlling light emitted from the fiber optic web.

In a further embodiment, the fiber optic web is carried between the exterior side of the mirror housing and the light transmissive panel.

In a further embodiment, the fiber optic web covers a rear side of the light transmissive panel so that light is uniformly emitted though the light transmissive panel.

In a further embodiment, the mirror housing adjacent the fiber optic web is opaque so that light emitted from the fiber optic web generally passes only through the light transmissive panel.

In a further embodiment, the light transmissive panel includes a web recess receiving the fiber optic web so that the light transmissive panel is carried flush against the exterior side of the mirror housing.

In a further embodiment, the fiber optic web includes a first distal end extending from the exterior side of the mirror housing to an interior side of the mirror housing; the first distal end connected to the light source and adapted for receiving light from the light source and directing the light into the fiber optic web.

In a further embodiment, the fiber optic web includes a second distal end extending from the exterior side of the mirror housing to an interior side of the mirror housing; the second distal end connected to a secondary light source and adapted for receiving light from the secondary light source and directing the light into the fiber optic web.

In a further embodiment, the first distal end includes a fiber optic cable interconnecting the fiber optic web to the light source, and the second distal end includes a fiber optic cable interconnecting the fiber optic web to the secondary light source.

In a further embodiment, the light source comprises at least one LED carried in the mirror housing.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a rear perspective view of the exterior vehicle mirror according to the present invention;

FIG. 2 shows an exploded rear perspective view of the exterior vehicle mirror according to the present invention;

FIG. 3 shows an interior elevation view of the mirror housing according to the present invention;

FIG. 4 shows a cross-section view of the mirror housing according to the present invention;,

FIG. 5A shows a detailed perspective view of a distal end of the light assembly according to the present invention;

FIG. 5B shows a detailed side cross-section view of a distal end of the light assembly according to the present invention; and,

FIG. 5C shows a detailed top cross-section view of a distal end of the light assembly according to the present invention.

### DETAILED DESCRIPTION OF A PREFERRED EMBODIMENT

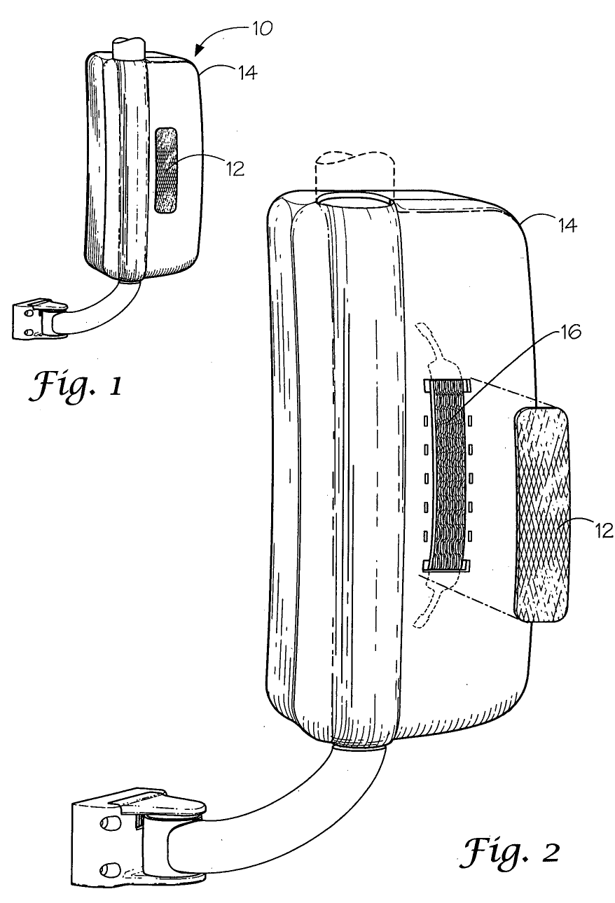

With reference to the drawings, the invention will now be described in more detail. Referring to FIG. 1, a rear view of an exterior vehicle mirror assembly, designated generally as 10, is shown having a slim profile lighting assembly for illuminating a light transmissive panel 12. The light transmissive panel 12 is disposed on an exterior side of a mirror housing 14. Referring to FIG. 2, a flat woven fiber optic web 16, is carried by mirror housing 14 behind light transmissive panel 12 and positioned adjacent light transmissive panel 12 when assembled as in FIG. 1.

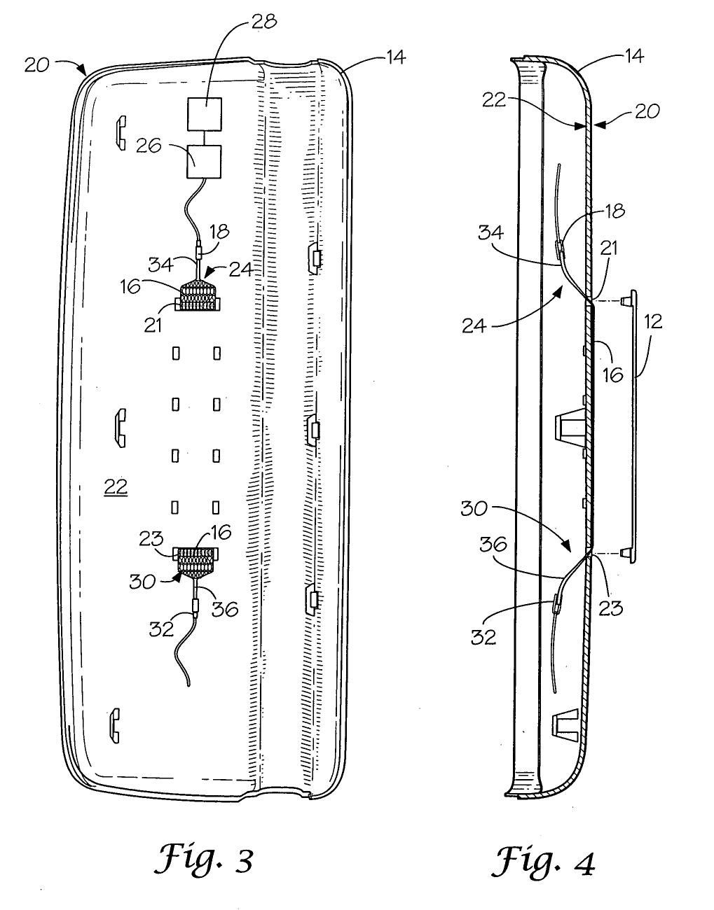

A flat woven fiber optic web of the type suitable for use in the present invention is manufactured by Lumitex, Inc., 8443 Dow Circle, Strongsville, Ohio 44136. The woven fiber optic web is constructed and arranged to not only channel light, but to emit light from various points along the strands of interlaced fiber optic cable as a result of its woven configuration. This provides a backlighting ability not obtainable from traditional fiber optic cabling that is designed to only emit light at an end point of the cable. Referring to FIG. 3, a light source 18 is connected to fiber optic web 16 for channeling light through the fiber optic web so that light emitted from the fiber optic web passes through light transmissive panel 12.

In the illustrated embodiment of FIG. 1, light transmissive panel 12 comprises a translucent reflector for controlling light emitted from fiber optic web 16. Alternatively, light transmissive panel 12 can be any fully transparent or semi-opaque panel, reflector, or even simply an opening in mirror housing 14 that allows light from fiber optic web 16 to exit the mirror housing.

Referring to FIG. 4, fiber optic web 16 is preferably carried between exterior side 20 of mirror housing 14 and light transmissive panel 12. This provides for limited interior intrusion by the lighting assembly into interior side 22 of mirror housing 14 to maximize interior space for other mirror assembly components. Additionally, it is preferred that mirror housing 14 adjacent fiber optic web 16 be opaque so that light emitted from fiber optic web 16 generally passes only through light transmissive panel 12. This helps prevent against light leakage that might otherwise radiate from an undesired location in mirror housing 14. Preferably, a reflective backing is applied to fiber optic web 16 adjacent mirror housing 14 to direct the maximum possible light through light transmissive panel 12. Alternatively, it is well known to use opaque tapes and other materials to insulate lighting components against light leakage within the mirror housing. Thus, the present invention is not limited to placing fiber optic web 16 between an opaque section of mirror housing 14 and light transmissive panel 12.

Further referring to FIG. 4, in the illustrated embodiment, fiber optic web 16 is of a size and shape to cover a rear side of light transmissive panel 12 so that light is uniformly emitted though the light transmissive panel. Because fiber optic web 16 can be woven in various shapes and sizes, it readily accommodates custom lighting applications not possible with traditional mirror lighting systems.

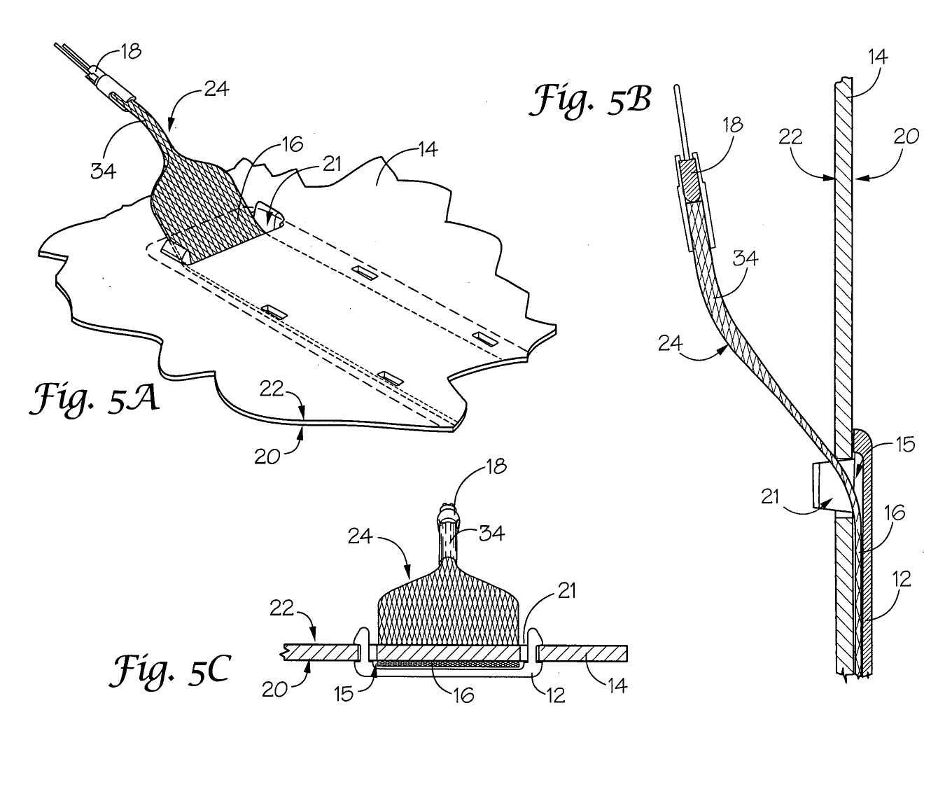

Referring to FIGS. 5B and 5C, in a further embodiment, light transmissive panel 12 may include a web recess, designated generally as 15, formed in a backside of light transmissive panel 12 disposed opposite exterior side 20 of mirror housing 14 when mounted. Web recess 15 is constructed and arranged to receive fiber optic web 16 so that fiber optic web 16 is recessed into the backside of light transmissive panel 12 to allow light transmissive panel 12 to extend over fiber optic web 16 and be mounted flush against exterior side 20 of mirror housing 14. Alternatively, web recess 15 could be formed in exterior side 20 of mirror housing 14.

Referring to FIGS. 3 and 5A-5C, in the illustrated embodiment, fiber optic web 16 includes a first distal end, designated generally as 24, extending from exterior side 20 of mirror housing 14 to interior side 22 of the mirror housing through web opening 21. First distal end 24 is connected to light source 18 and adapted for receiving light from light source 18 and directing the light into fiber optic web 16 for the desired lighting function. Light source 18 is operatively associated with a control unit 26 and a power supply 28 to operate the light assembly. Preferably, power supply 28 is the central vehicle power supply and control unit 26 can be any of various mechanisms operatively associate with the vehicle systems or an independent control switch to turn the light assembly on and off as desired.

For larger applications such as the illustrated embodiment, fiber optic web 16 includes a second distal end, designated generally as 30, extending from exterior side 20 of mirror housing 14 to interior side 20 of the mirror housing through web opening 23. As with first distal end 24, second distal end 30 is connected to a secondary light source 32 and adapted for receiving light from secondary light source 32 and directing the light into fiber optic web 16. Providing a light source at each end of the fiber optic web improves brightness and uniformity in larger fiber optic webbings.

Further, first distal end 24 includes a fiber optic cable 34 interconnecting fiber optic web 16 to light source 18, and second distal end 30 includes a fiber optic cable 36 interconnecting fiber optic web 16 to secondary light source 32. In a further embodiment, light sources 18 and 32 comprise at least one LED carried in the mirror housing. Given the improvements in LED brightness technology, only a single LED is typically required to provide sufficient illumination of the fiber optic web for most mirror light applications. As noted above, however, for larger application of the fiber optic web, it may be desirable to provide a second LED light source at the opposing end. As illustrated, light sources 18 and 32 are coupled to fiber optic cables 34 and 36 so that the distal ends of the fiber optic cables 34 and 36 are located adjacent the LEDs for maximum light transmission to channel the light from the light sources into fiber optic web 16. Preferably, fiber optic cables 34 and 36 are a bundle of individual fiber optic strands that extend from fiber optic web 16 and are secured together for channeling the light.

While a preferred embodiment of the invention has been described using specific terms, such description is for illustrative purposes only, and it is to be understood that changes and variations may be made without departing from the spirit or scope of the following claims.

What is claimed is:

1. A slim profile lighting assembly for an exterior rearview mirror comprising:
a light transmissive panel disposed on an exterior side of a mirror housing;
a flat woven fiber optic web carried by said housing adjacent said light transmissive panel; and,
a light source connected to said fiber optic web for channeling light through said fiber optic web so that light emitted from said fiber optic web passes through said light transmissive panel.

2. The lighting assembly of claim 1 wherein said light transmissive panel comprises a translucent reflector for controlling light emitted from said fiber optic web.

3. The lighting assembly of claim 1 wherein said fiber optic web is carried between said exterior side of said mirror housing and said light transmissive panel.

4. The lighting assembly of claim 3 wherein said fiber optic web covers a rear side of said light transmissive panel so that light is uniformly emitted though said light transmissive panel.

5. The lighting assembly of claim 3 wherein said mirror housing adjacent said fiber optic web is opaque so that light emitted from said fiber optic web generally passes only through said light transmissive panel.

6. The lighting assembly of claim 3 wherein said light transmissive panel includes a web recess receiving said fiber optic web so that said light transmissive panel is carried flush against said exterior side of said mirror housing.

7. The lighting assembly of claim 1 wherein said fiber optic web includes a first distal end extending from said exterior side of said mirror housing to an interior side of said mirror housing; said first distal end connected to said light source and adapted for receiving light from said light source and directing the light into said fiber optic web.

8. The lighting assembly of claim 7 wherein said fiber optic web includes a second distal end extending from said exterior side of said mirror housing to an interior side of said mirror housing; said second distal end connected to a secondary light source and adapted for receiving light from said secondary light source and directing the light into said fiber optic web.

9. The lighting assembly of claim 8 wherein said first distal end includes a fiber optic cable interconnecting said fiber optic web to said light source, and said second distal end includes a fiber optic cable interconnecting said fiber optic web to said secondary light source.

10. The lighting assembly of claim 1 wherein said light source comprises at least one LED carried in said mirror housing.

11. A slim profile lighting assembly for an exterior rearview mirror comprising:
a reflector carried on an exterior side of an opaque mirror housing;
a flat woven fiber optic web disposed on an exterior side of said mirror housing between said reflector and said mirror housing for emitting light to backlight said reflector;
a light source disposed in an interior of said mirror housing for providing light to said fiber optic web; and,
a first distal end of said fiber optic web extending through said mirror housing and including a fiber optic cable interconnecting said light source and said fiber optic web for channeling light to said fiber optic web to backlight said reflector.

12. The lighting assembly of claim 11 wherein said fiber optic web covers a rear side of said reflector so that light is uniformly emitted though said reflector.

13. The lighting assembly of claim 11 wherein said reflector includes a web recess receiving said fiber optic web so that said reflector is carried flush against said exterior side of said mirror housing.

14. The lighting assembly of claim 11 wherein a second distal end of said fiber optic web extends through said mirror housing and includes a second fiber optic cable interconnecting said fiber optic web with a second light source.

15. The lighting assembly of claim 11 wherein said light source comprises at least one LED carried in said mirror housing.

16. A slim profile lighting assembly for an exterior rearview mirror comprising:
a light transmissive panel carried by a mirror housing;
a flat woven fiber optic web disposed behind said light transmissive panel for emitting light through said light transmissive panel;
a first light source connected to a first distal end of said fiber optic web; and,
a second light source connected to a second distal end of said fiber optic web;
wherein said first and second light source cooperate to channel light through said fiber optic web so that light emitted from said fiber optic web passes through said light transmissive panel.

17. The lighting assembly of claim 16 wherein said light transmissive panel comprises a translucent reflector for controlling light emitted from said fiber optic web.

18. The lighting assembly of claim 17 wherein said fiber optic web is carried between an exterior side of said mirror housing and said light transmissive panel.

19. The lighting assembly of claim 18 wherein said fiber optic web covers a rear side of said light transmissive panel so that light is uniformly emitted though said light transmissive panel.

20. The lighting assembly of claim 19 wherein said mirror housing adjacent said fiber optic web is opaque so that light emitted from said fiber optic web generally passes only through said light transmissive panel.

21. The lighting assembly of claim 20 wherein said light transmissive panel includes a web recess receiving said fiber optic web so that said light transmissive panel is carried flush against said exterior side of said mirror housing.

22. The lighting assembly of claim 21 wherein each of said first and second light source comprise at least one LED carried in said mirror housing.

23. The lighting assembly of claim 22 wherein said first distal end extends from said exterior side of said mirror housing to an interior side of said mirror housing for connecting with said first light source.

24. The lighting assembly of claim 23 wherein said second distal end extending from said exterior side of said mirror housing to said interior side of said mirror housing for connecting with said second light source.

25. The lighting assembly of claim 24 wherein said first distal end includes a fiber optic cable interconnecting said fiber optic web to said first light source, and said second distal end includes a fiber optic cable interconnecting said fiber optic web to said second light source.
